(19) United States
(12) Patent Application Publication
(10) Pub. No.: US 2016/0364459 A1
(43) Pub. Date: Dec. 15, 2016

(54) SEARCH METHOD AND SEARCH DEVICE

(71) Applicant: Xiaomi Inc., Beijing (CN)

(72) Inventors: Xiaochuang LU, Beijing (CN); Yueyue CHU, Beijing (CN); Tao LIN, Beijing (CN)

(21) Appl. No.: 15/176,443

(22) Filed: Jun. 8, 2016

(30) Foreign Application Priority Data
Jun. 10, 2015 (CN) 201510316910.5

(51) Int. Cl. G06F 17/30

(52) U.S. Cl. CPC G06F 17/30554; G06F 17/30247

(57) ABSTRACT

The present disclosure relates to a search method and a search device. The method includes: displaying a search page including at least one characteristic image, each characteristic image corresponding to a search process and representing a characteristic of search results of the corresponding search process; upon receiving an instruction of selecting a first characteristic image, performing a first search process corresponding to the first characteristic image, to obtain search results corresponding to the first search process; and displaying the search results corresponding to the first search process.

### CROSS-REFERENCE TO RELATED APPLICATIONS

This application is based upon and claims priority to Chinese Patent Application No. 201510316910.5, filed Jun. 10, 2015, the entire contents of which are incorporated herein by reference.

### TECHNICAL FIELD

The present disclosure relates to the field of computer technology and, more particularly, to a search method and a search device.

### BACKGROUND

With the development of mobile terminal technology, mobile terminals have been in more and more widespread use, and have become one of the most important tools in people's daily work and life. A user of a mobile terminal often needs to perform search operations on the mobile terminal, such as searching for the news about an event, or pictures of certain type.

When using the mobile terminal to perform a search, the user often needs to enter in a search bar keywords to be searched, for example, “landscape picture,” and then click a search button. Subsequently, the terminal will search for information related to the keywords and display the search results. In the example of “landscape picture,” the terminal will display the searched landscape pictures.

### SUMMARY

According to a first aspect of the present disclosure, there is provided a search method, comprising: displaying a search page including at least one characteristic image, each characteristic image corresponding to a search process and representing a characteristic of search results of the corresponding search process; upon receiving an instruction of selecting a first characteristic image, performing a first search process corresponding to the first characteristic image, to obtain search results corresponding to the first search process; and displaying the search results corresponding to the first search process.

According to a second aspect of the present disclosure, there is provided a search device, comprising: a processor; and a memory for storing instructions executable by the processor; wherein the processor is configured to: display a search page including at least one characteristic image, each characteristic image corresponding to a search process and representing a characteristic of search results of the corresponding search process; upon receiving an instruction of selecting a first characteristic image, perform a first search process corresponding to the first characteristic image, to obtain search results corresponding to the first search process; and display the search results corresponding to the first search process.

According to a third aspect of the present disclosure, there is provided a non-transitory computer-readable storage medium storing instructions that, when executed by one or more processors of a device, cause the device to perform a search method, the method comprising: displaying a search page including at least one characteristic image, each characteristic image corresponding to a search process and representing a characteristic of search results of the corresponding search process; upon receiving an instruction of selecting a first characteristic image, performing a first search process corresponding to the first characteristic image, to obtain search results corresponding to the first search process; and displaying the search results corresponding to the first search process.

It is to be understood that both the foregoing general description and the following detailed description are exemplary and explanatory only and are not restrictive of the invention, as claimed.

### BRIEF DESCRIPTION OF THE DRAWINGS

The accompanying drawings herein, which are incorporated into and constitute a part of the specification, illustrate embodiments consistent with the present disclosure, and together with the description, serve to explain the principles of the present disclosure.

FIG. 1 is a flowchart of a search method, according to an exemplary embodiment.

FIG. 2 is a schematic diagram illustrating a display interface of a terminal, according to an exemplary embodiment.

FIG. 3 is a schematic diagram illustrating a display interface of a terminal, according to an exemplary embodiment.

FIG. 4 is a block diagram of a search device, according to an exemplary embodiment.

FIG. 5 is a block diagram of a search device, according to an exemplary embodiment.

FIG. 6 is a block diagram of a search device, according to an exemplary embodiment.

FIG. 7 is a block diagram of a terminal, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the invention as recited in the appended claims.

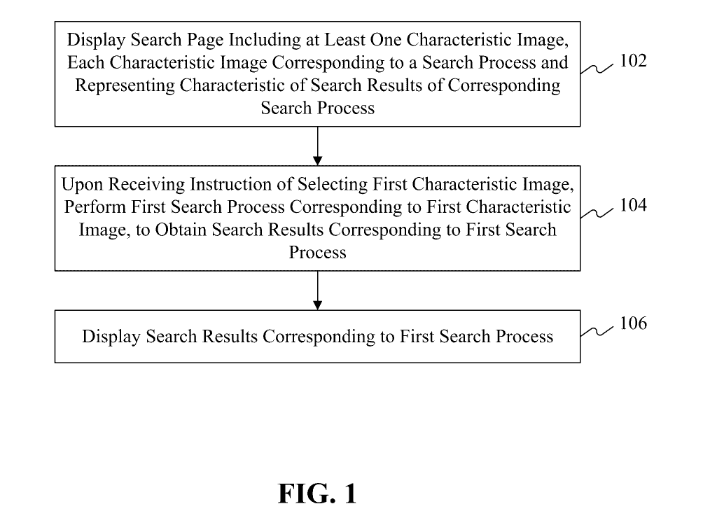

FIG. 1 is a flowchart of a search method 100, according to an exemplary embodiment. For example, the method 100 may be used in a terminal As shown in FIG. 1, the method 100 includes the following steps.

In step 102, the terminal displays a search page. The search page includes at least one characteristic image. Each characteristic image corresponds to a search process and is configured to represent a characteristic of the search results of the corresponding search process.

In step 104, upon receiving a selection of a first characteristic image, the terminal performs a first search process corresponding to the first characteristic image, to obtain search results corresponding to the first search process.

In step 106, the terminal displays the search results corresponding to the first search process.

According to the method 100, the user performs a search by selecting a characteristic image on the search page, without manually entering keywords to be searched. Therefore, the search efficiency is improved.

In exemplary embodiments, the method 100 may be applied in a terminal that has a search function. The terminal may be a mobile terminal, such as a mobile phone or a tablet computer. An application for performing the search function is installed on the terminal. The terminal may include an input unit, which may be one or more buttons, a touch screen, or a mouse. Through the input unit, the user selects, on the terminal, a first characteristic image corresponding to a first search process that is desired to be performed. The terminal will then detect the selection. The terminal may also include a processor. Based on the detected selection of the first characteristic image, the processor performs the first search process to obtain corresponding search results. The terminal may further include a display unit, such as a liquid crystal display. The display unit displays on the display unit the search results corresponding to the first search process. Besides the above-described components, the terminal may further include a memory, a sensor, an audio circuit, a power supply, and other components.

Hereinafter, the implementations of the method 100 (FIG. 1) will be described in detail as follows.

As described above, in step 102, the terminal displays a search page. The search page includes at least one characteristic image. Each characteristic image corresponds to a search process and is used to represent a characteristic of the search results of the corresponding search process.

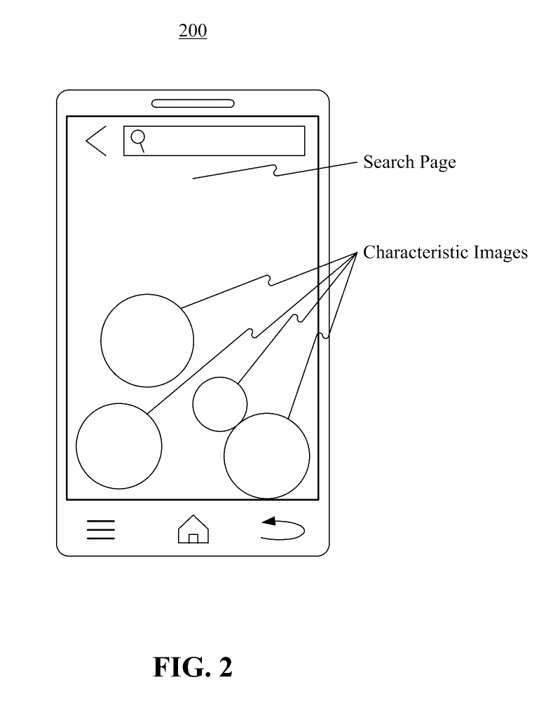

In practice, the user installs on the terminal an application that has a search function. The application is shown as an icon on the terminal When the user clicks the icon of the application, the terminal will activate the application. In the application, the user may click an option corresponding to the search page. Then the terminal will receive the click operation and display the corresponding search page. The search page includes at least one characteristic image. Each characteristic image corresponds to a search process. FIG. 2 is a schematic diagram illustrating a display interface 200 of the terminal, according to an exemplary embodiment. As shown in FIG. 2, each characteristic image is used to represent a characteristic of the search results of the search process. For example, the application with a search function may be an application for downloading mobile phone themes. The application can perform a search process to search for blue themes, purple themes, and so on. The characteristic images corresponding to these themes are respectively a blue balloon and a purple balloon, both of which are displayed on the search page. Shapes and sizes of the characteristic images on the search page may be the same or different. For example, the characteristic images may be a plurality of balloons with the same shape and size, or a plurality of balloons with different shapes and sizes. In addition, the search page may include a search bar. The user enters in the search bar the keywords to be searched, and clicks a search button to perform a search.

In some embodiments, the terminal determines the characteristic images to be displayed in the search page based on the respective search frequency of each characteristic image. The detailed procedure is as follows: first, the terminal obtains the characteristic images corresponding to a preset number of search processes that are most frequently performed within a preset historical time duration; and second, the terminal displays a search page including the obtained characteristic images.

In practice, the characteristic images corresponding to the preset number of search processes that are performed most frequently within the preset historical time duration, are determined based on the search records of all the terminal that are installed with the application. When a user performs a search process on a terminal, the respective terminal performs the search process, and sends a corresponding search request to a back-end server for the application. After receiving the search request, the back-end server sends searched results to the terminal and stores information about the search process (for example, identifier of the search process, time cost for performing the search process, etc.). The specific procedure for performing a search process will be described below in more detail.

The back-end server records the search processes performed by all the terminals installed with the application installed, so as to obtain the search records within the preset historical time duration. Based on the search records, the back-end server calculates the total number of times each search process is performed within the preset historical time duration, and determines a preset number of search processes that are most frequently performed. For example, the preset number of the most frequently performed search processes is 3. Based on the search records, the back-end server determines that, within the past 30 days, the total number of times of searching for blue themes is 2250, the total number of times of searching for purple themes is 3520, the total number of times of searching for red themes is 1864, and the total number of times of searching for green themes is 2179. Therefore. the back-end server determines that the three most frequently performed search processes are the searches for purple themes, blue themes, and green themes.

After determining the preset number of search processes that are most frequently performed within the preset historical time duration, the back-end server sends identifiers of the determined search processes to the terminal in the form of a push message. Alternatively, after receiving a request from the terminal for obtaining the most frequently performed search processes, the back-end server sends identifiers of the determined search processes to the terminal. After receiving identifiers of the determined search processes from the back-end server, the terminal identifies the determined search processes based on these identifiers. The terminal then obtains the characteristic images corresponding to the determined search processes, and displays the obtained characteristic images on the search page. The terminal may display the characteristic images at preset positions of the search page.

In some embodiments, the terminal determines the characteristic images to be displayed on the search page based on the search records of a local login account within a preset historical time duration. The detailed procedure is as follows: the terminal obtains the characteristic images corresponding to a preset number of search processes that are most frequently performed by a local login account within a preset historical time duration.

In practice, the characteristic images corresponding to the preset number of search processes that are performed most frequently within the preset historic time duration are determined based on the search records of the local login account within the preset historic time duration. When a user performs a search through a local login account on the terminal, the terminal performs the corresponding search process and stores information about the search process (for example, identifier of the search process, time cost for performing the search process, etc.), so as to obtain the search records of the local login account.

Based on the search records of the local login account, the terminal calculates the total number of times each search process is performed by the local login account within the preset historical time duration, and determines a preset number of search processes that are most frequently performed. For example, the preset number of the most frequently performed search processes is 3. Based on the search records, the terminal determines that, for the local login account within the past 30 days, the total number of times of searching for blue themes is 250, the total number of times of searching for purple themes is 260, the total number of times of searching for red themes is 164, and the total number of times of searching for green themes is 179. Therefore, the terminal determines that the three most frequently performed search processes are the searches for purple themes, blue themes, and green themes.

After determining the preset number of search processes that are most frequently performed by the local login account within the preset historical time duration, the terminal obtains the characteristic images corresponding to the determined search processes and displays on the search page the obtained characteristic images. The terminal may display the characteristic images at preset positions of the search page.

In some embodiments, the display effect of the characteristic images is set to be a dynamic display.

In practice, when the display effect of a characteristic image is set as a dynamic display, the dynamic display may have various forms. For example, the characteristic image may be set as moving between left and right, moving up and down, or moving along a locus that a preset curve.

In step 104, upon receiving an instruction of selecting a first characteristic image, the terminal performs a first search process corresponding to the first characteristic image, to obtain the search results corresponding to the first search process.

In practice, a plurality of search processes are preset in the terminal. Each search process is further set to correspond to a characteristic image, such that a corresponding relationship is established between the search processes and the characteristic images. When a user wants to perform a search, the user selects a characteristic image (i.e., the first characteristic image) on the search page. When receiving the instruction of selecting the first characteristic image, the terminal determines a first search process corresponding to the first characteristic image, according to the pre-established corresponding relationship between the search processes and the characteristic images. The terminal then performs the first search process.

The terminal also stores identifiers of the search processes. Upon receiving an instruction of selecting the first characteristic image, the terminal determines an identifier of the first search process that corresponds to the first characteristic image. and then sends to a back-end server of the application a search request corresponding to the first search process. The search request carries the identifier of the first search process. The back-end server pre-stores search results corresponding to various identifiers of search processes. After receiving the search request, the back-end server analyzes the search request, determines the identifier of the first search process, and queries a local database to obtain the search results corresponding to the identifier of the first search process. The back-end server then sends the obtained search results to the terminal. For example, the back-end server may store 100 blue themes corresponding to an identifier of a search process of searching for blue themes, store 40 red themes corresponding to an identifier of a search process of searching for red themes, and store 80 green themes corresponding to an identifier of a search process of searching for green themes. Upon receiving a search request for blue themes, the back-end server sends data regarding the 100 blue themes to the terminal.

In step 106, the terminal displays the search results corresponding to the first search process.

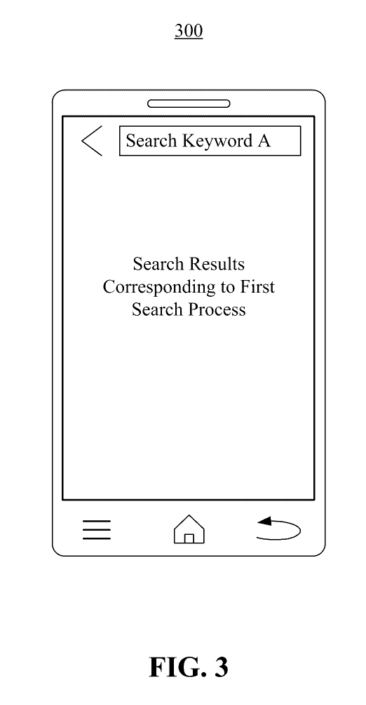

In practice, after obtaining the search results corresponding to the first search process, the terminal displays a search-result page, and displays the search results corresponding to the first search process on the search-result page. Further, the terminal also stores search keywords corresponding to each characteristic image. For example, corresponding to a search process of searching for blue themes, the characteristic image is a blue balloon, and the search keywords are “blue themes”. FIG. 3 is a schematic diagram illustrating a display interface 300 of the terminal, according to an exemplary embodiment. As shown in FIG. 3, the display interface 300 displays a search-result page. Besides displaying the search results corresponding to the first search process, the search-result page also displays the search keywords (for example, search keyword A) corresponding to the first characteristic image to prompt the user.

In some embodiments, the user of the terminal adds a characteristic image to the search page. The detailed procedure is as follows. First, the terminal receives an instruction of adding a search process, and displays a search-process adding page. The search-process adding page includes at least one characteristic image. Each characteristic image corresponds to a search process. Second, the terminal receives an instruction of selecting a second characteristic image on the search-process adding page, and adds the second characteristic image to the search page.

In practice, the search page displays a search-process adding option. When the user clicks the search-process adding option, the terminal receives the instruction of adding search processes, and displays a search-process adding page. The search-process adding page displays at least one characteristic image, with each characteristic image corresponding to a search process. On the search-process adding page, the user selects a characteristic image (i.e., the second characteristic image) corresponding to the search process that is desired to be added. The terminal then receives the instruction of selecting the second characteristic image, and adds the second characteristic image to the search page.

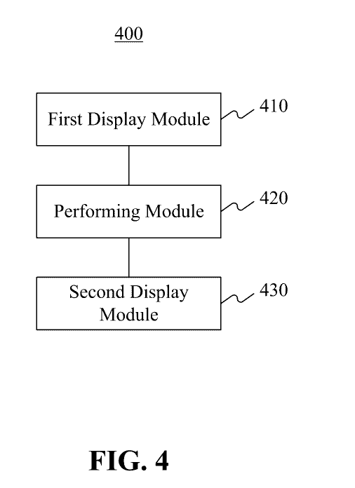

FIG. 4 is a block diagram of a search device 400, according to an exemplary embodiment. As shown in FIG. 4, the device 400 includes a first display module 410, a performing module 420, and a second display module 430.

The first display module 410 is configured to display a search page including at least one characteristic image. Each search page corresponds to a search process and represents a characteristic of the search results of the corresponding search process.

The performing module 420 is configured to, upon receiving an instruction of selecting a first characteristic image, perform a first search process corresponding to the first characteristic image, to obtain search results corresponding to the first search process.

The second display module 430 is configured to display the search results corresponding to the first search process.

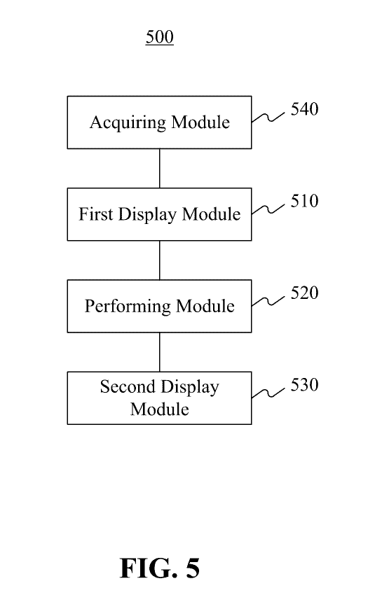

FIG. 5 is a block diagram of a search device 500, according to an exemplary embodiment. As shown in FIG. 5, the search device 500 includes a first display module 510, a performing module 520, and a second display module 530, similar to the first display module 410, the performing module 420, and the second display module 430 (FIG. 4).

In some embodiments, the search device 500 further includes an acquiring module 540. The acquiring module 540 is configured to obtain characteristic images corresponding to a preset number of search processes that are most frequently performed within a preset historical time duration. Accordingly, the first display module 510 is further configured to display a search page including the obtained characteristic images.

In some embodiments, the acquiring module 540 is further configured to determine a preset number of search processes that are most frequently performed by a local login account within a preset historical time duration, and obtain characteristic images corresponding to the preset number of search processes.

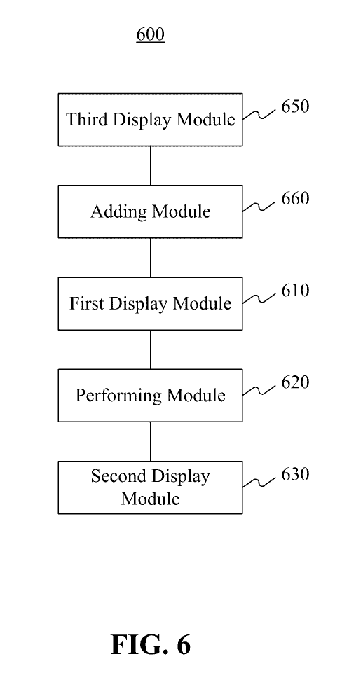

FIG. 6 is a block diagram of a search device 600, according to an exemplary embodiment. As shown in FIG. 6, the search device 600 includes a first display module 610, a performing module 620, and a second display module 630, similar to the first display module 410, the performing module 420, and the second display module 430 (FIG. 4).

In some embodiments, the search device 600 further includes a third display module 650 and an adding module 660. The third display module 650 is configured to receive an instruction of adding search processes, and display a search-process adding page. The search-process adding page displays at least one characteristic image, with each characteristic image corresponding to a search process. The adding module 660 is configured to receive an instruction of selecting a second characteristic image on the search-process adding page, and add the second characteristic image to the search page.

In some embodiments, display modules of the search devices 400-600 (i.e., the first display modules 410, 510, and/or 610, and/or the third display module 650) are configured to display the characteristic image with a preset display effect. For example, the preset display effect may be a dynamic display.

With respect to the search devices 400-600 in the above embodiments, the specific operations executed by various modules thereof have been described in detail in the embodiments illustrating the method 100, which are not described herein any further.

With the search devices 400-600, the user performs searches by selecting a characteristic image on the search page, without manually entering the keywords to be searched. Therefore, the search efficiency is improved.

It should be noted that, in the above embodiments, the division of the search devices into the functional modules is provided for illustrative purpose only. In practice, the functions of the search devices may be assigned to any functional modules for implementation as required. Specifically, the internal structures of the search devices are divided into different functional modules to implement all or part of the above-described functions. In addition, the search devices according to the above embodiments are based on the same inventive concept as the search methods according to the embodiments of the present disclosure.

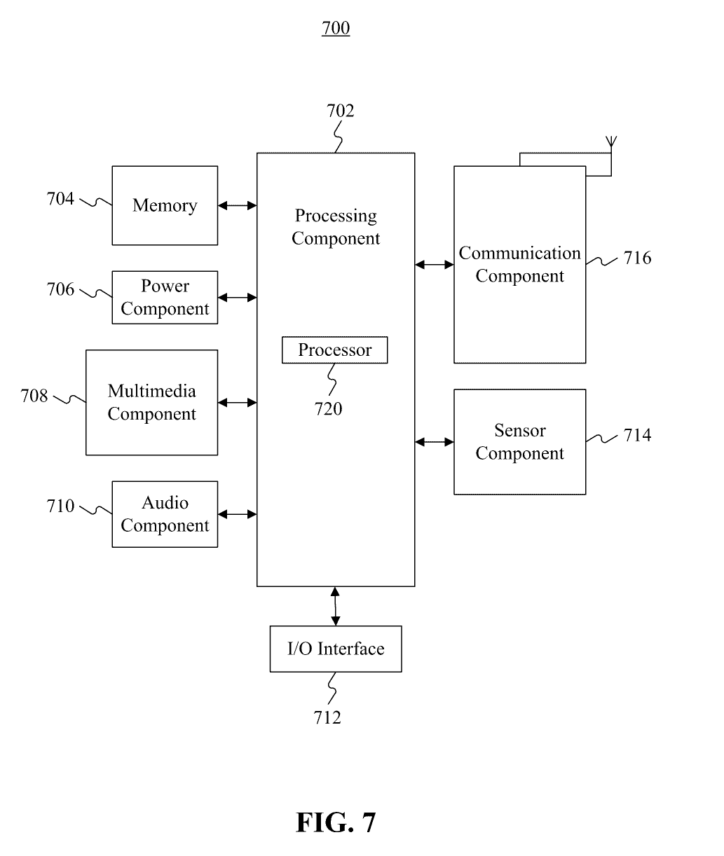

FIG. 7 is a block diagram of a terminal 700 for performing search functions consistent with the present disclosure, according to an exemplary embodiment. For example, the terminal 700 may be a mobile phone and the like.

Referring to FIG. 7, the terminal 700 includes one or more of the following components: a processing component 702, a memory 704, a power component 706, a multimedia component 708, an audio component 710, an input/output (I/O) interface 712, a sensor component 714, and a communication component 716.

The processing component 702 typically controls overall operations of the terminal 700, such as the operations associated with display, telephone calls, data communications, camera operations, and recording operations. The processing component 702 may include one or more processors 720 to execute instructions to perform all or a part of the steps in the above-described methods. In addition, the processing component 702 may include one or more modules which facilitate the interaction between the processing component 702 and other components. For example, the processing component 702 may include a multimedia module to facilitate the interaction between the multimedia component 708 and the processing component 702.

The memory 704 is configured to store various types of data to support the operations of the terminal 700. Examples of such data include instructions for any application or method operated on the terminal 700, contact data, phonebook data, messages, pictures, videos, and the like. The memory 704 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory

(PROM), a read-only memory (ROM), a magnetic memory, a flash memory, a magnetic or optical disk.

The power component 706 provides power to various components of the terminal 700. The power component 706 may include a power management system, one or more power supplies, and other components associated with the generation, management, and distribution of power in the terminal 700.

The multimedia component 708 includes a screen providing an output interface between the terminal 700 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 708 includes a front camera and/or a rear camera. The front camera and/or the rear camera may receive external multimedia data while the terminal 700 is in an operation mode, such as a photographing mode or a video mode. Each of the front camera and the rear camera may be a fixed optical lens system or have focus and optical zoom capability.

The audio component 710 is configured to output and/or input audio signals. For example, the audio component 710 includes a microphone configured to receive an external audio signal when the terminal 700 is in an operation mode, such as a call mode, a recording mode, or a voice recognition mode. The received audio signal may be further stored in the memory 704 or transmitted via the communication component 716.

The I/O interface 712 provides an interface between the processing component 702 and a peripheral interface module, such as a keyboard, a click wheel, a button, or the like. The buttons may include, but are not limited to, a home button, a volume button, a starting button, and a locking button.

The sensor component 714 includes one or more sensors to provide status assessments of various aspects of the terminal 700. For example, the sensor component 714 may detect an open/closed status of the terminal 700, relative positioning of components, e.g., the display and the keypad, of the terminal 700, a change in position of the terminal 700 or a component of the terminal 700, a presence or absence of user contact with the terminal 700, an orientation or an acceleration/deceleration of the terminal 700, and a change in temperature of the terminal 700. The sensor component 714 may include a proximity sensor configured to detect the presence of nearby objects without any physical contact. The sensor component 714 may also include a light sensor, such as a CMOS or CCD image sensor, for use in imaging applications. In some embodiments, the sensor component 714 may also include an accelerometer sensor, a gyroscope sensor, a magnetic sensor, a pressure sensor, or a temperature sensor.

The communication component 716 is configured to facilitate communications, wired or wireles sly, between the terminal 700 and other devices. The terminal 700 may access a wireless network based on a communication standard, such as WiFi, 2G, 3G, 4G, or a combination thereof. In one exemplary embodiment, the communication component 716 receives a broadcast signal or broadcast associated information from an external broadcast management system via a broadcast channel In one exemplary embodiment, the communication component 716 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the terminal 700 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above-described methods.

In exemplary embodiments, there is also provided a non-transitory computer-readable storage medium including instructions, such as included in the memory 704, executable by the processor 720 in the terminal 700, for performing the above-described methods. For example, the non-transitory computer-readable storage medium may be a ROM, a random access memory (RAM), a compact disc read-only memory (CD-ROM), a magnetic tape, a floppy disc, an optical data storage device, or the like.

One of ordinary skill in the art will understand that the above-described modules can each be implemented by hardware, or software, or a combination of hardware and software. One of ordinary skill in the art will also understand that multiple ones of the above-described modules may be combined as one module, and each of the above-described modules may be further divided into a plurality of sub-modules.

Other embodiments of the present disclosure will be apparent to those skilled in the art from consideration of the specification and practice disclosed herein. This application is intended to cover any variations, uses, or adaptations of the present disclosure following the general principles thereof and including such departures from the present disclosure as coming within common knowledge or customary technical means in the art. It is intended that the specification and embodiments be considered as exemplary only, with a true scope and spirit of the invention being indicated by the appended claims.

It will be appreciated that the present disclosure is not limited to the exact construction that has been described above and illustrated in the accompanying drawings, and that various modifications and changes can be made without departing from the scope thereof. The scope of the present disclosure is only defined by the appended claims.

1. A search method, comprising:
displaying a search page including at least one characteristic image, each characteristic image corresponding to a search process and representing a characteristic of search results of the corresponding search process;
upon receiving an instruction of selecting a first characteristic image, performing a first search process corresponding to the first characteristic image, to obtain search results corresponding to the first search process; and
displaying the search results corresponding to the first search process.

2. The method according to claim 1, wherein the displaying of the search page including at least one characteristic image further comprises:
obtaining characteristic images corresponding to a preset number of search processes that are most frequently performed within a preset time duration; and
displaying the obtained characteristic images on the search page.

3. The method according to claim 2, wherein the obtaining of the characteristic images corresponding to the preset number of search processes that are most frequently performed within the preset time duration further comprises:
determining the preset number of search processes that are most frequently performed by a local login account within the preset time duration; and
obtaining the characteristic images corresponding to the preset number of search processes.

4. The method according to claim 1, further comprising:
receiving an instruction of adding a search process, and displaying a search-process adding page, the search-process adding page including at least one characteristic image; and
receiving an instruction of selecting a second characteristic image on the search-process adding page, and adding the second characteristic image to the search page.

5. The method according to claim 1, wherein a display effect of the characteristic image is set to be a dynamic display.

6. A search device, comprising:
a processor; and
a memory for storing instructions executable by the processor;
wherein the processor is configured to:
display a search page including at least one characteristic image, each characteristic image corresponding to a search process and representing a characteristic of search results of the corresponding search process;
upon receiving an instruction of selecting a first characteristic image, perform a first search process corresponding to the first characteristic image, to obtain search results corresponding to the first search process; and
display the search results corresponding to the first search process.

7. The device according to claim 6, wherein the processor is further configured to:
obtain characteristic images corresponding to a preset number of search processes that are most frequently performed within a preset time duration; and
display the obtained characteristic images on the search page.

8. The device according to claim 7, wherein the processor is further configured to:
determine the preset number of search processes that are most frequently performed by a local login account within the preset time duration; and
obtain the characteristic images corresponding to the preset number of search processes.

9. The device according to claim 6, wherein the processor is further configured to:
receive an instruction of adding a search process, and display a search-process adding page, the search-process adding page including at least one characteristic image; and
receive an instruction of selecting a second characteristic image on the search-process adding page, and add the second characteristic image to the search page.

10. The device according to claim 6, wherein a display effect of the characteristic image is set to be a dynamic display.

11. A non-transitory computer-readable storage medium storing instructions that, when executed by one or more processors of a device, cause the device to perform a search method, the method comprising:
displaying a search page including at least one characteristic image, each characteristic image corresponding to a search process and representing a characteristic of search results of the corresponding search process;
upon receiving an instruction of selecting a first characteristic image, performing a first search process corresponding to the first characteristic image, to obtain search results corresponding to the first search process; and
displaying the search results corresponding to the first search process.

12. The medium according to claim 11, wherein the displaying of the search page including at least one characteristic image further comprises:
obtaining characteristic images corresponding to a preset number of search processes that are most frequently performed within a preset time duration; and
displaying the obtained characteristic images on the search page.

13. The medium according to claim 12, wherein the obtaining of the characteristic images corresponding to the preset number of search processes that are most frequently performed within the preset time duration further comprises:
determining the preset number of search processes that are most frequently performed by a local login account within the preset time duration; and
obtaining the characteristic images corresponding to the preset number of search processes.

14. The medium according to claim 11, wherein the search method further comprises:
receiving an instruction of adding a search process, and displaying a search-process adding page, the search-process adding page including at least one characteristic image; and
receiving an instruction of selecting a second characteristic image on the search-process adding page, and adding the second characteristic image to the search page.

15. The medium according to claim 11, wherein a display effect of the characteristic image is set to be a dynamic display.
